(19) United States
(12) Patent Application Publication
(10) Pub. No.: US 2012/0043251 A1
(43) Pub. Date: Feb. 23, 2012

(54) Packaging material for meats

(76) Inventor: Wilfred Nykamp, Sherbrooke (CA)

(21) Appl. No.: 13/136,290

(22) Filed: Jul. 27, 2011

(30) Foreign Application Priority Data
Aug. 19, 2010 (CA) 2,713,672

(51) Int. Cl. B65D 65/40; B65B 25/06; B32B 27/32; B65D 85/00; B32B 7/02

(52) U.S. Cl. 206/524.2; 428/339; 442/290; 428/216; 53/461

(57) ABSTRACT

A wrapping material for a food product which comprises a layer of cotton and a layer of a polyolefin material extruded on one side of the cotton, the polyolefin having a thickness of at least 0.001 of an inch. The wrapping material may be used for meats such as bologna and sausage.

The present invention relates to a wrapping material, a wrapped cold cut meat package, and a method for wrapping a cold cut meat.

### FIELD OF THE INVENTION

It is known in the art to wrap cold cut meat in a cotton material. The cotton material represents a traditional wrapping. The cotton is soaked in a hot wax which controls water evaporation from the meat.

### BACKGROUND OF THE INVENTION

One of the main disadvantages of traditional cotton packaging is that, for certain types of products, the dimensions are not stable. Before adding the meat, the cotton must be soaked in hot water in order to facilitate filling and this causes uncontrolled shrinkage. For example, a package of 14.3 c. in diameter can easily shrink by an amount of 0.6 to 10.0 mm. While it is possible to weigh each tube individually to adjust the final weight of the package, the preferred process uses continuous tubes which are automatically cut to a predefined length depending on the final product. Each piece of meat is then inserted into a second vacuum packaging on which the weight is printed beforehand. Naturally, the diameter variations can result in inaccurate weight printed on the vacuum packaging. These variations can be significant enough to bring the package outside of the normal tolerance applicable to the weight printed on the packaging.

Another potential disadvantage of traditional cotton packaging is that the meat, when cooked, sticks to the cotton packaging causing an inconvenience to the consumer when it is time to use the product.

Also, the traditional cotton packaging method suffers from the disadvantage that once the tubes are filled and the meat is cooked, the tubes have to be soaked with a hot paraffin mixture and then hung for cooling. This paraffin coating is essential to prevent weight loss and drying of the product; however, this step increases the manufacturing costs so that the product is no longer viable in a competitive manufacturing environment. The increased costs are incurred by the price of the paraffin, the longer cycle time and associated labour.

In order to overcome this problem, some manufacturers have turned to the use of synthetic packaging which has more stable dimensions. However, this leads to significantly higher manufacturing costs and as well, the package loses the desired feel of the “old fashioned” packaging.

### SUMMARY OF THE INVENTION

It is an object of the present invention to provide a packaging suitable for meat such as sausages.

It is a further object of the present invention to provide a method for the packaging of meat such as sausages.

It is a still further object of the present invention to provide a improved wrapped meat product.

According to one aspect of the present invention there is provided a wrapping material for a food product comprising a layer of cotton, a layer of a polyolefin material extruded on one side of the cotton, the polyolefin having a thickness of at least 0.001 inch.

According to a further aspect of the present invention there is provided a food package comprising a cold cut meat, a wrapping material extending about the cold cut meat, the wrapping material comprising an inner layer of polyolefin and an outer layer of cotton, the polyolefin having a thickness of at least 0.001 inch.

According to a still further aspect of the present invention there is provided a method of packing cold cut meat comprising the steps of supplying a cold cut meat, and wrapping the cold cut meat in a wrapping material comprised of a layer of cotton and a layer of polyolefin, the polyolefin lying adjacent the cold cut meat, the polyolefin having a thickness of at least 0.001 inch.

The cotton used in the practice of the present invention is preferably an undyed 100% food grade raw cotton fabric which does not contain chlorine or other undesirable chemicals. Preferably, the cotton will be a one by one plain weave with between 76 and 84 threads per inch. In a preferred embodiment, the cotton will have a weight of approximately between 4.0 and 4.4 oz. per square yard.

The polyolefin is preferably a low density polyethylene which is approved for use with food. The polyester is applied, preferably by extrusion, to coat one side of the cotton with a layer of preferably between 0.001 to 0.002 inches. The polymer cotton combination is, on a weight basis, a ratio of 1 to 6. The material, after coating, preferably has a water vapour transmission lower than 2.0 grams per 100 square inches in 24 hours.

The cold cut meat may include any conventional meats such as sausage, salami, bologna, etc.

### BRIEF DESCRIPTION OF THE DRAWINGS

Having thus generally described the invention, reference will be made to the accompanying drawings illustrating an embodiment thereof, in which:

FIG. 1 is a cut away view of the wrapping of the present invention;

FIG. 2 is a perspective view of the packaging material formed into a cylinder to receive a food product.

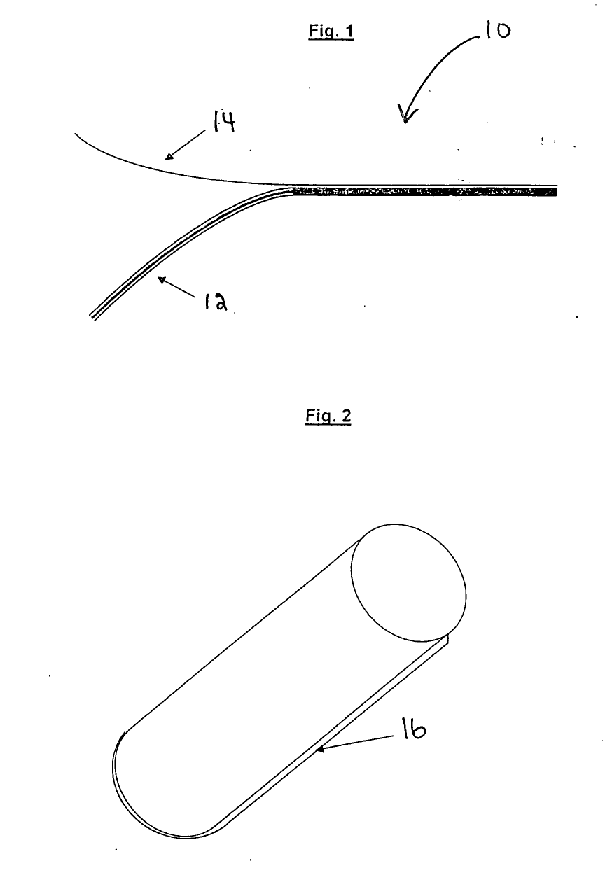

### DETAILED DESCRIPTION OF THE INVENTION

Referring to the drawings in greater detail and by reference characters thereto, there is illustrated a portion of the wrapping material generally designated by reference numeral 10 and which has an outer layer 12 formed of a cotton material having the properties previously set forth. An inner polyolefin layer 14 is adhered to one surface of outer cotton layer 12.

As shown in FIG. 2, wrapping material 10 is formed into a tube 16 to receive a cold cut meat.

It will be understood that the above described embodiment is for purposes of illustration only and that changes and modifications may be made thereto without departing from the spirit and scope of the invention.

We claim:

1. A wrapping material for a food product comprising:
a layer of cotton;
a layer of a polyolefin material extruded on one side of said cotton; said polyolefin having a thickness of at least 0.001 inch.

2. The wrapping material of claim 1 wherein said polyolefin is low density polyethylene.

3. The wrapping material of claim 3 wherein said material has a steam transmission rate below 2.0 grams per 100 square inches per 24 hours.

4. The wrapping material of claim 1 wherein said cotton is a simple weave containing between 76 and 84 threads per inch and having a weight of between 4.0 and 4.4 ounces per square yard.

5. The wrapping material of claim 4 wherein said low density polyethylene has a thickness of between 0.001 and 0.002 inches.

6. A food package comprising:
a cold cut meat;
a wrapping material extending about said cold cut meat, said wrapping material comprising an inner layer of polyolefin and an outer layer of cotton, said polyolefin having a thickness of at least 0.001 inch.

7. The food package of claim 6 wherein said polyolefin is low density polyethylene.

8. The food package of claim 7 wherein said material has a steam transmission below 2.0 grams per 100 square inches per 24 hours.

9. The food package of claim 8 wherein said cotton is a simple weave containing between 76 and 84 threads per inch and having a weight of between 4.0 and 4.4 ounces per square yard.

10. The food package of claim 9 wherein said low density polyethylene has a thickness of between 0.001 and 0.002 inches.

11. A method of packing cold cut meat comprising the steps of supplying a cold cut meat, and wrapping said cold cut meat in a wrapping material comprised of a layer of cotton and a layer of polyolefin, said polyolefin lying adjacent said cold cut meat, said polyolefin having a thickness of at least 0.001 inch.
